(19) United States
(12) Patent Application Publication
(10) Pub. No.: US 2013/0129142 A1
(43) Pub. Date: May 23, 2013

(54) AUTOMATIC TAG GENERATION BASED ON IMAGE CONTENT

(71) Applicant: Jose Emmanuel Miranda-Steiner, Redmond, WA (US)

(72) Inventor: Jose Emmanuel Miranda-Steiner, Redmond, WA (US)

(73) Assignee: Microsoft Corporation, Redmond, WA (US)

(21) Appl. No.: 13/298,310

(22) Filed: Nov. 17, 2011

(51) Int. Cl. G06K 9/00

(52) U.S. Cl. 382/103

(57) ABSTRACT

Automatic extraction of data from and tagging of a photo (or video) having an image of identifiable objects is provided. A combination of image recognition and extracted metadata, including geographical and date/time information, is used to find and recognize objects in a photo or video. Upon finding a matching identifier for a recognized object, the photo or video is automatically tagged with one or more keywords associated with and corresponding to the recognized objects.

### BACKGROUND

As digital cameras become ever more pervasive and digital storage becomes cheaper, the number of photographs (“photos”) and videos in a collection (or library) of a user will also grow exponentially.

Categorizing those photos is time consuming, and it is a challenge for users to quickly find images of particular moments in their life. Currently, tags are used to aid in the sorting, saving, and searching of digital photos. Tagging refers to a process of assigning keywords to digital data. The digital data can then be organized according to the keywords or ‘tags’. For example, the subject matter of a digital photo can be used to create keywords that are then associated with that digital photo as one or more tags.

Although tags can be manually added to a particular digital photo to help in the categorizing and searching of the photos, there are currently only a few automatic tags that are added to photos. For example, most cameras assign automatic tags of date and time to the digital photos. In addition, more and more cameras are including geographic location as part of the automatic tags of a photo. Recently, software solutions have been developed to provide automatic identification of the people in photos (and matching to a particular identity).

However, users are currently limited to querying photos by date, geography, people tags, and tags that are manually added.

### BRIEF SUMMARY

Methods for automatically assigning tags to digital photos and videos are provided. Instead of only having tags from metadata providing date, time, and geographic location that may be automatically assigned to a photo by a camera, additional information can be automatically extracted from the photo or video and keywords or code associated with that additional information can be automatically assigned as tags to that photo or video. This additional information can include information not obviously available directly from the image and the metadata associated with the image.

For example, information regarding certain conditions including, but not limited to, weather, geographical landmarks, architectural landmarks, and prominent ambient features can be extracted from an image. In one embodiment, the time and geographic location metadata of a photo is used to extract the weather for that particular location and time. The extraction can be performed by querying weather databases to determine the weather for the particular location and time in which the photo was taken. In another embodiment, geographic location metadata of a photo and image recognition is used to extract geographical and architectural landmarks. In yet another embodiment, image recognition is used to extract prominent ambient features (including background, color, hue, and intensity) and known physical objects from images, and tags are automatically assigned to the photo based on the extracted features and objects.

According to one embodiment, a database of keywords or object identifiers can be provided to be used as tags when one or more certain conditions are recognized in a photo. When a particular condition is recognized, one or more of the keywords or object identifiers associated with that particular condition are automatically assigned as tags for the photo.

Tags previously associated with a particular photo can be used to generate additional tags. For example, date information can be used to generate tags with keywords associated with that date, such as the season, school semester, holiday, and newsworthy event.

In a further embodiment, recognized objects can be ranked by prominence and the ranking reflected as an additional tag. In addition, the database used in identifying the recognized objects can include various levels of specificity/granularity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an automatic tag generation process in accordance with certain embodiments of the invention.

FIG. 2 illustrates an image recognition process in accordance with certain embodiments of the invention.

FIG. 3 shows an automatic tag generation process flow in accordance with certain embodiments of the invention.

FIG. 4 illustrates a process of generating a tag by extracting an architectural landmark from a photo for an automatic tag generation process in accordance with an embodiment of the invention.

FIG. 5 illustrates a process of generating a tag by extracting a geographical landmark from a photo for an automatic tag generation process in accordance with an embodiment of the invention.

### DETAILED DESCRIPTION

Techniques are described for performing automatic generation of one or more tags associated with a photo. The automatic tagging can occur as a digital photo (or video) is loaded or otherwise transferred to a photo collection that may be stored on a local, remote, or distributed database. In other embodiments, the automatic tagging can occur upon the initiation of a user in order to tag existing photos.

An image can include, but is not limited to, the visual representation of objects, shapes, and features of what appears in a photo or a video frame. According to certain embodiments, an image may be captured by a digital camera (in the form of a photo or as part of a video), and may be realized in the form of pixels defined by image sensors of the digital camera. In some embodiments the term “photo image” is used herein to refer to the image of a digital photo as opposed to metadata or other elements associated with the photo and may be used interchangeably with the term “image” without departing from the scope of certain embodiments of the invention. The meaning of the terms “photo,” “image,” and “photo image” will be readily understood from their context.

In certain embodiments, an image, as used herein, may refer to the visual representation of the electrical values obtained by the image sensors of a digital camera. An image file (and digital photo file) may refer to a form of the image that is computer-readable and storable in a storage device. In certain embodiments, the image file may include, but is not limited to, a .jpg, .gif, and .bmp. The image file can be reconstructed to provide the visual representation (“image”) on, for example, a display device or substrate (e.g., by printing onto paper).

Although some example embodiments may be described with reference to a photo, it should be understood that the same may be applicable to any image (even those not captured by a camera). Further, the subject techniques are applicable to both still images (e.g., a photograph) and moving images (e.g., a video), and may include audio components to the file.

Metadata written into a digital photo file often includes information identifying who owns the photo (including copyright and contact information) and the camera (and settings) that created the file, as well as descriptive information such as keywords about the photo for making the file searchable on a user's computer and/or over the Internet. Some metadata is written by the camera, while other metadata is input by a user either manually or automatically by software after transferring the digital photo file to a computer (or server) from a camera, memory device, or another computer.

According to certain embodiments of the invention, an image and its metadata are used to generate additional metadata. The additional metadata is generated by being extracted or inferred from the image and the metadata for the image. The metadata for the image can include the geo-location and date the image was taken, and any other information associated with the image that is available. The metadata for the image can be part of the image itself or provided separately. When the metadata is part of the image itself, the data is first extracted from the digital file of the image before being used to generate the additional metadata. Once generated, the additional metadata can then be associated back to the original image or used for other purposes. The extracted and/or created metadata and additional metadata can be associated with the original image as a tag.

One type of tag is a keyword tag. The keyword tag may be used in connection with performing operations on one or more images such as, for example, sorting, searching and/or retrieval of image files based on tags having keywords matching specified criteria.

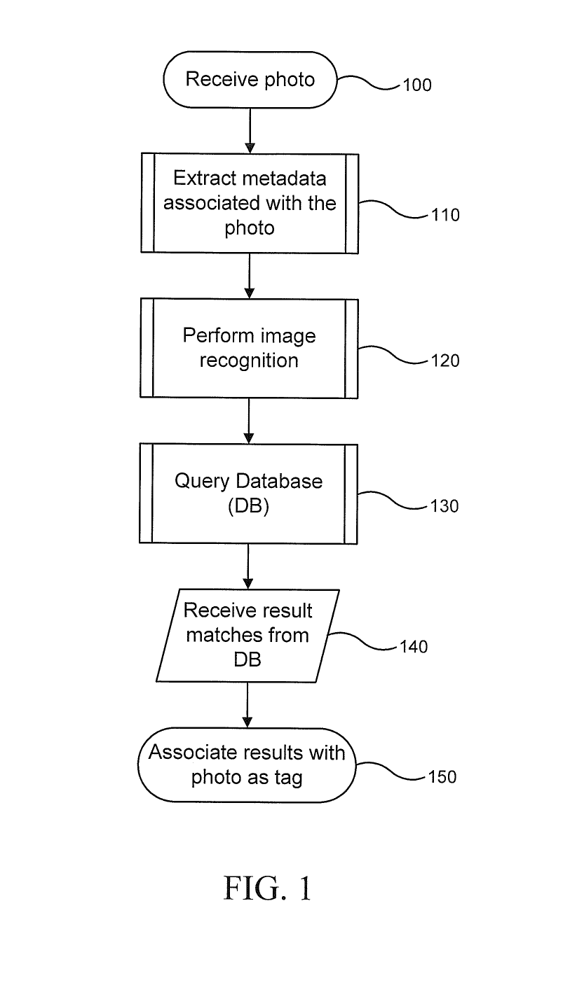

FIG. 1 illustrates an automatic tag generation process in accordance with certain embodiments of the invention.

Referring to FIG. 1, a photo having an image and corresponding metadata is received 100. The automatic tagging process of an embodiment of the invention can automatically begin upon receipt of the photo. For example, the process can begin upon the user uploading a photo image file to a photo sharing site. As another example, the process can begin upon the user loading the photo from a camera onto a user's computer. As yet another example, a user's mobile phone can include an application for automatic tag generation where upon capturing an image using the mobile phone's camera or selecting the application, the tagging process can begin.

After receiving the photo, metadata associated with the photo is extracted 110. The extraction of the metadata can include reading and parsing the particular type(s) of metadata associated with the photo. The types of metadata that can be extracted may include, but are not limited to Exchangeable Image File Format (EXIF), International Press Telecommunication Council (IPTC), and Extensible Metadata Platform (XMP).

In addition to metadata extraction 110, image recognition is performed 120 to recognize and identify shapes and objects in the photo image. The particular image recognition algorithm used during the performing of the image recognition can be any suitable image or pattern recognition algorithm available for the particular application or processing constraints. The image recognition algorithm may be limited by available databases for providing the matching of objects in the photo to known objects. As one example, an image recognition algorithm can involve pre-processing of the image. Pre-processing can include, but is not limited to, adjusting the contrast of the image, converting to greyscale and/or black and white, cropping, resizing, rotating, and a combination thereof.

According to certain image recognition algorithms, a distinguishing feature, such as (but not limited to) color, size, or shape, can be selected for use in detecting a particular object. Of course, multiple features providing distinguishing characteristics of the object may be used. Edge detection (or border recognition) may be performed to determine edges (or borders) of objects in the image. Morphology may be performed in the image recognition algorithm to conduct actions on sets of pixels, including the removal of unwanted components. In addition, noise reduction and/or filling of regions may be performed.

As part of one embodiment of an image recognition algorithm, once the one or more objects (and their associated properties) are found/detected in the image, the one or more objects can each be located in the image and then classified. The located object(s) may be classified (i.e. identified as a particular shape or object) by evaluating the located object(s) according to particular specifications related to the distinguishing feature(s). The particular specifications may include mathematical calculations (or relations). As another example, instead of (or in addition to) locating recognizable objects in the image, pattern matching may be performed. Matching may be carried out by comparing elements and/or objects in the image to “known” (previously identified or classified) objects and elements. The results (e.g., values) of the calculations and/or comparisons may be normalized to represent a best fit for the classifications, where a higher number (e.g., 0.9) signifies a higher likelihood of being correctly classified as the particular shape or object than a normalized result of a lower number (e.g., 0.2). A threshold value may be used to assign a label to the identified object. According to various embodiments, the image recognition algorithms can utilize neural networks (NN) and other learning algorithms.

It should be understood that although certain of the described embodiments and examples may make reference to a photo, this should not be construed as limiting the described embodiments and examples to a photo. For example, a video signal can be received by certain systems described herein and undergo an automatic tag generation process as described in accordance with certain embodiments of the invention. In one embodiment, one or more video frames of a video signal can be received, where the video frame may include an image and metadata, and image recognition and metadata extraction can be performed.

In one embodiment, a first pass recognition step can be performed for an image to identify that a basic shape or object exists in the image. Once the basic shape or object is identified, a second pass recognition step is performed to obtain a more specific identification of the shape or object. For example, a first pass recognition step may identify that a building exists in the photo, and a second pass recognition step may identify the specific building. In one embodiment, the step of identifying that a building exists in the photo can be accomplished by pattern matching between the photo and a set of images or patterns available to the machine/device performing the image recognition. In certain embodiments, the result of the pattern matching for the first pass recognition step can be sufficient to identify the shape or object with sufficient specificity such that no additional recognition step is performed.

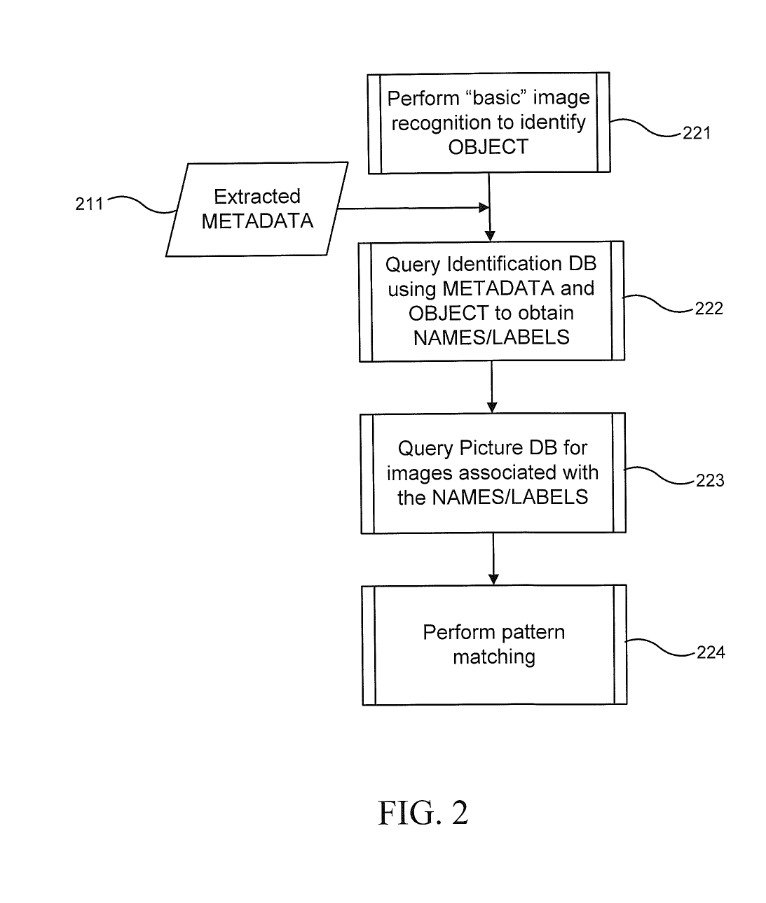

In certain embodiments, during the image recognition process, the extracted metadata can be used to facilitate the image recognition by, for example, providing hints as to what the shape or object in the photo may be. In the building example for the first pass/second pass process, geographical information extracted from the metadata can be used to facilitate the identification of the specific building. In one embodiment, the performing of the image recognition 120 can be carried out using the image recognition process illustrated in FIG. 2. Referring to FIG. 2, a basic image recognition algorithm can be used to identify an object in an image 221. This image recognition algorithm is referred to as “basic” to indicate that the image recognition process in step 221 is not using the extracted metadata and should not be construed as indicating only a simplistic or otherwise limited process. The image recognition algorithm can be any suitable image or pattern recognition algorithm available for the particular application or processing constraints, and can also involve pre-processing of the image. Once an object is identified from the image, the extracted metadata 211 can be used to obtain a name or label for the identified object by querying a database (e.g., “Identification DB”) 222. The database can be any suitable database containing names and/or labels providing identification for the object within the constraints set by the query. The names and/or labels resulting from the Identification DB query can then be used to query a database (e.g., “Picture DB”) containing images to find images associated with the names and/or labels 223. The images resulting from the Picture DB search can then be used to perform pattern matching 224 to more specifically identify the object in the image. In certain embodiments, a score can be provided for how similar the images of objects resulting from the Picture DB search are to the identified object in the image undergoing the image recognition process.

Using the building example above and an image recognition process in accordance with an embodiment of the image recognition process described with respect to FIG. 2, the basic image recognition 221 may be used to identify the OBJECT “building” and the algorithm may return, for example, “building,” “gray building,” or “tall building.” When the extracted metadata 211 is the longitude and latitude at which the photo was taken (may be within a range on the order of ˜10² feet), a query of an Identification DB 222 may be “find all buildings close to this geographical location” (where the geographical location is identified using the longitude and latitude provided by the extracted metadata). Then, the Picture DB can be queried 223 to “find all known pictures for each of those specific buildings” (where the specific buildings are the identified buildings from the query of the Identification DB). Pattern matching 224 can then be performed to compare the images obtained by the query of the Picture DB with the image undergoing the image recognition process to determine whether there is a particularly obvious or close match.

In a further embodiment, when multiple objects are identified in a single image, the relative location of objects to one another may also be recognized. For example, an advanced recognition step can be performed to recognize that an identified boat is on an identified river or an identified person is in an identified pool.

Returning to FIG. 1, the extracted metadata and recognized/identified objects in the photo can then be used to obtain additional information for the photo by being used in querying databases for related information 130. Word matching can be performed to obtain results from the query. This step can include using geographical information, date/time information, identified objects in the image, or various combinations thereof to query a variety of databases to obtain related information about objects in the photo and events occurring in or near the photo. The results of the database querying can be received 140 and used as tags for the photo 150. For example, a photo having an extracted date of Nov. 24, 2011, an extracted location in the United States, and a recognized object of a cooked turkey on a table can result in an additional information tag of “Thanksgiving,” whereas an extracted location of outside of the United States would not necessarily result in the tag of the additional information of “Thanksgiving” for the same image. As another example, a photo having an extracted date of the 2008 United States presidential election and an image recognized President Obama can result in an additional information tag of “presidential election” or, if the time also matches, the additional information tag can include “acceptance speech.”

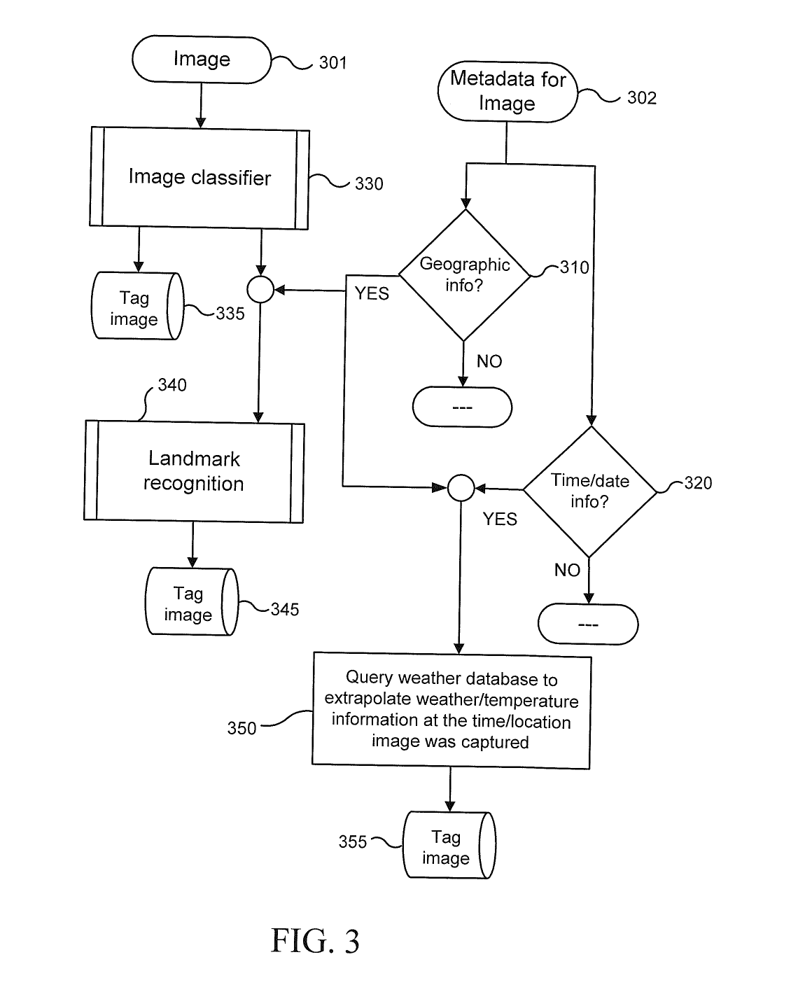

FIG. 3 illustrates an automatic tagging process in accordance with certain embodiments of the invention. Similar to the process described with respect to FIG. 1, a photo having an image 301 and corresponding metadata 302 is received. Any geographic information (310) and date/time information (320) available from the metadata 202 is extracted. If no geographic information and date/time information is available, a null result may be returned (as an end process). In addition, the image 301 is input into an image classifier 330 that scans for known objects (i.e. objects having been defined and/or catalogued in a database used by the image classifier) and identifies and extracts any known physical objects in the image.

The image classifier uses a database of shapes and items (objects) to extract as much data as possible from the image. The image classifier can search and recognize a variety of objects, shapes, and/or features (e.g., color). Objects include, but are not limited to, faces, people, products, characters, animals, plants, displayed text, and other distinguishable content in an image. The database can include object identifiers (metadata) in association with the recognizable shapes and items (objects). In certain embodiments, the sensitivity of the image classifier can enable identification of an object even where only partial shapes or a portion of the object is available in the image. The metadata obtained from the image classifier process can be used as tags for the photo. The metadata may be written back into the photo or otherwise associated with the photo and stored (335).

From the extracted metadata and the metadata obtained from the image classifier process, additional tags can be automatically generated by utilizing a combination of the metadata. For example, the image can undergo one or more passes for identification and extraction of a variety of recognized features. During the identification and extraction of the variety of recognized features, a confidence value representing a probability that the recognized feature was correctly identified can be provided as part of the tag associated with the photo. The confidence value may be generated as part of the image recognition algorithm. In certain embodiments, the confidence value is the matching weight (which may be normalized) generated by the image recognition algorithm when matching a feature/object in the image to a base feature (or particular specification). For example, when a distinguishing characteristic being searched for in an image is that the entire picture is blue, but an image having a different tone of blue is used in the matching algorithm, the generated confidence value will depend on the algorithm being used and the delta between the images. In one case, the result may indicate a 90% match if the algorithm recognizes edges and colors, and in another case, the result may indicate a 100% match if the algorithm is only directed to edges, not color.

In certain embodiments, the confidence values can be in the form of a table with levels of confidence. The table can be stored as part of the tags themselves. In one embodiment, the table can include an attribute and associated certainty. For example, given a photo of a plantain (in which it is not clear that the plantain is a plantain or a banana), the photo (after undergoing an automatic tag generation process in accordance with an embodiment of the invention) may be tagged with Table 1 below. It should be understood that the table is provided for illustrative purposes only and should not be construed as limiting the form, organization, or attribute selection.

TABLE 1

| Attribute | Certainty |
|---|---|
| Fruit | 1 |
| Banana | 0.8 |
| Plantain | 0.8 |
| Hot Dog | 0 |

For the above example, when a user is searching for photos of a banana, the photo of the plantain may be obtained along with the Table 1. The user may, in some cases, be able to remove any attributes in the table that the user knows are incorrect and change the confidence value (or certainty) of the attribute the user knows is correct to 100% (or 1). In certain embodiments, the corrected table and photo can be used in an image matching algorithm to enable the image recognition algorithm to be more accurate.

Returning to FIG. 3, in one embodiment, the extracted geographical information is used to facilitate a landmark recognition pass (340), through which the image is input, to identify and extract any recognized landmarks (geographical or architectural). Confidence values can also be associated with the tags generated from the landmark recognition pass. The tags generated from the landmark recognition pass can be written back into the photo image file or otherwise associated with the image and stored (345).

In a further embodiment, a weather database is accessed to extrapolate the weather/temperature information at the time/location at which the image was captured by using the extracted metadata of geographical information and date/time information (350). The weather/temperature information can be written back into the photo or otherwise associated with the photo and stored (355). The automatic tags generated from each process may be stored in a same or separate storage location.

Multiple databases can be used by the automatic tag generating system. The databases used by the tag generating system can be local databases or databases associated with other systems. In one embodiment, a database can be included having keywords or object identifiers for use as tags when one or more specific conditions such as (but not limited to) the weather, geographical landmarks, and architectural landmarks, are determined to be present in a photo. This database can be part of or separate from the database used and/or accessed by the image classifier. The databases accessed and used for certain embodiments of the subject automatic tag generation processes can include any suitable databases available to search engines, enabling matching between images and tags.

The process of adding geographical identification information (as metadata) to a photo can be referred to as “geotagging.” Generally, geotags include geographical location information such as the latitudinal and longitudinal coordinates of the location where a photo is captured. Automatic geotagging typically refers to using a device (e.g., digital still camera, digital video camera, mobile device with image sensor) having a geographical positioning system (GPS) when capturing the image for a photo such that the GPS coordinates are associated with the captured image when stored locally on the image capturing device (and/or uploaded into a remote database). In other cases, CellID (also referred to as CID and which is the identifying number of a cellular network cell for a particular cell phone operator station or sector) may be used to indicate location. In accordance with certain embodiments of the invention, a specialized automatic geotagging for geographical and architectural landmarks can be accomplished.

As a first example, the date/time and location information of a digital photo can be extracted from metadata of the digital photo and a database searched using the date/time and location codes. The database can be a weather database, where a query for the weather at the location and date/time extracted from the digital photo returns information (or code) related to the weather for that particular location and time. For example, the result of the query can provide weather code and/or descriptions that can be used as a tag such as “Mostly Sunny,” “Sunny,” “Clear,” “Fair,” “Partly Cloudy,” “Cloudy,” “Mostly Cloudy,” “Rain,” “Showers,” “Sprinkles,” and “T-storms.” Of course, other weather descriptions may be available or used depending on the database being searched. For example, the weather code may include other weather related descriptors such as “Cold,” “Hot,” “Dry,” and “Humid” Seasonal information can also be included.

In some cases, the weather database being searched may not store weather information for the exact location and time used in the query. In one embodiment of such a case, a best matching search can be performed and weather information (along with a confidence value) can be provided for possible best matches to the location and date/time. For example, a weather database may contain weather information updated for each hour according to city. A query of that weather database could then return the weather information for the city that the location falls within or is nearest (e.g., the location may be outside of designated city boundaries) for the closest time(s) to the particular time being searched.

Once the photo is tagged with the weather information from the weather database, a query for “find me pictures that were taken while it was snowing” would include photos having the automatically generated weather tag of “Snow.”

As described above, in addition to using metadata (and other tags) associated with a photo, image recognition is performed on the photo image to extract feature information and a tag associated with the recognized object or feature is automatically assigned to the photo.

As one example, prominent ambient features can be extracted from photos by using image (or pattern) recognition. Predominant colors can be identified and used as a tag. The image recognition algorithms can search for whether sky is a prominent feature in the photo and what colors or other highlights are in the photo. For example, the image recognition can automatically identify “blue sky” or “red sky” or “green grass” and the photo can be tagged with those terms.

As a second example, using image recognition known physical objects can be automatically extracted and the photos in which those known physical objects are found automatically tagged with the names of the known physical objects. In certain embodiments, image recognition can be used to find as many objects as possible and automatically tag the photo appropriately. If a baseball bat, or a football, or a golf club, or a dog, is detected by the image recognition algorithm, tags with those terms can be automatically added as tags to the photo. In addition the objects could be automatically ranked by prominence. If the majority of the image is determined to be of a chair, but there is also recognized a small baseball sitting on a table (with a small portion of the table viewable in the image), the photo can be tagged “chair,” “baseball,” and “table.” In further embodiments, an extra tag can be included with an indicator that the main subject is (or is likely to be) a chair.

Depending on the particular database of image recognizable objects, the granularity of the tags can evolve. For example, the database can have increasing granularity of recognizable objects, such as “automobile” to “BMW automobile” to “BMW Z4 automobile.”

As a third example, known geographic landmarks can be determined and the information extracted from a photo by using a combination of image recognition and geotagging. Data from the photo image itself can be extracted via image recognition and the image recognized shapes or objects compared to known geographic landmarks at or near the location corresponding to the location information extracted from the metadata or geotag of the photo. This can be accomplished by querying a database containing geographical landmark information. For example, the database can be associated with a map having names and geographic locations of known rivers, lakes, mountains, and valleys. Once it is recognized that a geographic landmark is in the photo and the name of the geographic landmark is determined, the photo can be automatically tagged with name of the geographic landmark.

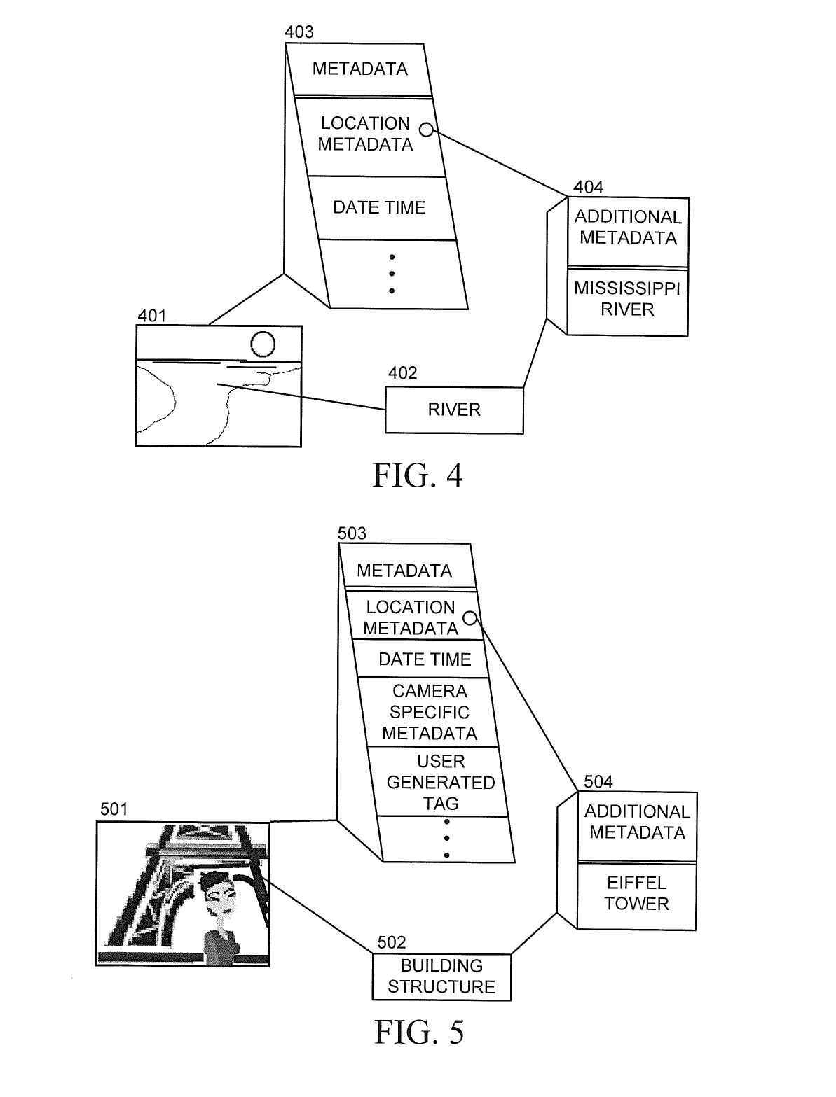

For example, the existence of a body of water in the photo image may be recognized using image recognition. Combining the recognition that water is in the photograph with a geotag associated with the photograph that indicates that the location the photo image was captured is on or near a particular known body of water can result in automatic generation of tags for the photo of the name of the known body of water. For example, a photo with a large body of water and a geotag indicating a location in England along the river Thames can be automatically tagged with “River Thames” and “River.” FIG. 4 illustrates one such process. Referring to FIG. 4, image recognition of a photo image 401 showing sunrise over a river can result in a determination that a river 402 is in the image 401. Upon determining that there is a river in the photo image, this information can then be extracted from the image and applied as a tag and/or used in generating the additional metadata. For example, a more specific identification for the “river” 402 can be achieved using the photo's corresponding metadata 403. The metadata 403 may include a variety of information such as location metadata and date time metadata.

For the geographical landmark tag generation, the combination of the location metadata (from the metadata 403) and the image-recognized identified object (402) is used to generate additional metadata. Here, the metadata 403 indicates a location (not shown) near the Mississippi River and the image recognized object is a river. This results in the generation of the identifier “Mississippi River,” which can be used as a tag for the photo.

In certain embodiments, such as when there is no geographic information providing a name for a particular geographical landmark, a shape or object that is recognized as being a river can be tagged with “River.” Similarly, a shape or object that is recognized as being a beach can be tagged with “Beach” or “Coast.”

As a fourth example, known architectural landmarks can also be determined from a photo by using a combination of image recognition and geotagging. Data from the photo image itself can be extracted via image recognition and the image recognized shapes or objects compared to known architectural landmarks at or near the location corresponding to the location information extracted from the metadata or geotag of the photo. This can be accomplished by querying a database containing architectural landmark information. Once it is recognized that an architectural landmark is in the photo and the name of the architectural landmark is determined, the photo can be automatically tagged with name of the architectural landmark. Architectural landmarks including the Eiffel tower, the Great Wall of China, or the Great Pyramid of Giza can be recognized due to their distinctive shapes and/or features. The existence of a particular structure in the photo may be recognized using image recognition and the photo tagged with a word associated with that structure or feature. The name of the particular structure determined from searching a database can be an additional tag.

For example, if image recognition results in determining a pyramid is in the photo and the photo's geo-tagging indicates that the photo was taken near the pyramid of Giza, then the photo can be tagged with “Pyramid of Giza” (or “Great Pyramid of Giza) in addition to “Pyramid.” FIG. 5 illustrates one such process. Referring to FIG. 5, image recognition of a photo image 501 showing a person in front of the base of the Eiffel tower can result in a determination that a building structure 502 is in the image 501. By determining that there is a building structure in the photo image, this information can then be extracted from the image and applied as a tag and/or used in generating the additional metadata. In certain embodiments where this information is extracted (e.g., that there is a building structure in the photo image), the photo can be tagged with a word or words associated with the image-recognized object of “building structure.” A more specific identification for the “building structure” can be achieved using the photo's corresponding metadata 503. The metadata 503 can include a variety of information such as location metadata and date time metadata. In certain embodiments, the metadata 503 of the photo can also include camera specific metadata and any user generated or other automatically generated tags. This listing of metadata 503 associated with the photo should not be construed as limiting or requiring the particular information associated with the photo and is merely intended to illustrate some common metadata.

For the architectural landmark tag generation, the combination of the location metadata (from the metadata 503) and the image-recognized identified object (502) is used to generate additional metadata. Here, the metadata 503 indicates a location (not shown) near the Eiffel tower and the image recognized object is a building structure. This results in the generation of the identifier “Eiffel tower,” which can be used as a tag for the photo.

Similar processes can be conducted to automatically generate a tag of recognizable objects. For example, if a highway is recognized in a photo, the photo can be tagged as “highway.” If a known piece of art is recognized, then the photo can be tagged with the name of the piece of art. For example, a photo of Rodin's sculpture, The Thinker, can be tagged with “The Thinker” and “Rodin.” The known object database can be one database or multiple databases that may be accessible to the image recognition program.

In one embodiment, the image recognition processing can be conducted after accessing a database of images tagged or associated with the location at which the photo was taken, enabling additional datasets for comparison.

In an example involving moving images (e.g., video), a live video stream (having audio and visual components) can be imported and automatically tagged according to image recognized and extracted data from designated frames. Ambient sound can also undergo recognition algorithms to have features of the sound attached as a tag to the video. As some examples, speech and tonal recognition, music recognition, and sound recognition (e.g., car horns, clock tower bells, claps) can be performed. By identifying tonal aspects of voices on the video, the video can be automatically tagged with emotive based terms, such as “angry.”

In addition to the examples provided herein, it should be understood that any number of techniques can be used to detect an object within an image and to search a database to find information related to that detected object, which can then be associated with the image as a tag.

The above examples are not intended to suggest any limitation as to the scope of use or functionality of the techniques described herein in connection with automatically generating one or more types of tags associated with an image.

In certain embodiments, the environment in which the automatic tagging occurs includes a user device and a tag generator provider that communicates with the user device over a network. The network can be, but is not limited to, a cellular (e.g., wireless phone) network, the Internet, a local area network (LAN), a wide area network (WAN), a WiFi network, or a combination thereof. The user device can include, but is not limited to a computer, mobile phone, or other device that can store and/or display photos or videos and send and access content (including the photos or videos) via a network. The tag generator provider is configured to receive content from the user device and perform automatic tag generation. In certain embodiments, the tag generator provider communicates with or is a part of a file sharing provider such as a photo sharing provider. The tag generator provider can include components providing and carrying out program modules. These components (which may be local or distributed) can include, but are not limited to, a processor (e.g., a central processing unit (CPU)) and memory.

In one embodiment, the automatic tagging can be accomplished via program modules directly as part of a user device (which includes components, such as a processor and memory, capable of carrying out the program modules). In certain of such embodiments, no tag generator provider is used. Instead, the user device communicates with database providers (or other user or provider devices having databases stored thereon) over the network or accesses databases stored on or connected to the user device.

Certain techniques set forth herein may be described in the general context of computer-executable instructions, such as program modules, executed by one or more computers or other devices. Generally, program modules include routines, programs, objects, components, and data structures that perform particular tasks or implement particular abstract data types. In various embodiments, the functionality of the program modules may be combined or distributed as desired over a computing system or environment. Those skilled in the art will appreciate that the techniques described herein may be suitable for use with other general purpose and specialized purpose computing environments and configurations. Examples of computing systems, environments, and/or configurations include, but are not limited to, personal computers, server computers, hand-held or laptop devices, multiprocessor systems, microprocessor-based systems, programmable consumer electronics, and distributed computing environments that include any of the above systems or devices.

It should be appreciated by those skilled in the art that computer readable media includes removable and nonremovable structures/devices that can be used for storage of information, such as computer readable instructions, data structures, program modules, and other data used by a computing system/environment, in the form of volatile and non-volatile memory, magnetic-based structures/devices and optical-based structures/devices, and can be any available media that can be accessed by a user device. Computer readable media should not be construed or interpreted to include any propagating signals.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of automatic tag generation, comprising:
receiving an image;
extracting metadata from an image file associated with the image, including any geographic information related to a location at which the image was captured;
performing image recognition to identify an object in the image;
determining at least one specific condition corresponding to the object and the location at which the image was captured by:
querying a database for at least one specific condition matching the object and the location at which the image was captured, and
receiving information or code associated with the at least one specific condition from the database; and
automatically tagging the image with the information or code associated with the at least one specific condition.

2. The method according to claim 1, wherein the image comprises a frame of a video.

3. The method according to claim 1, further comprising automatically tagging the image with a word or code associated with the object in the image after performing the image recognition to identify the object in the image.

4. The method according to claim 3, wherein automatically tagging the image with the word or code associated with the object comprises assigning a keyword and confidence value related to recognition level of the object in the image.

5. The method according to claim 1, wherein performing the image recognition comprises recognizing a shape or partial shape of the object in the image.

6. The method according to claim 5, wherein performing the image recognition further comprises using the geographical information and the recognized shape or partial shape to identify the object.

7. The method according to claim 1, wherein performing the image recognition comprises determining ambient features of the image.

8. The method according to claim 1, wherein querying the database comprises accessing the database over a network.

9. The method according to claim 1, wherein the information or code associated with the at least one specific condition comprises an event information or code, a weather information or code, a geographical landmark information or code, an architectural landmark information or code, or a combination thereof.

10. The method according to claim 1, wherein querying the database for at least one specific condition matching the object and the location at which the image was captured comprises:
querying a geographical or architectural landmark database using the geographic information related to the location at which the image was captured and information related to the object to find information on a particular geographical or architectural landmark matching the location at which the image was captured and the identified object.

11. A method of automatic tag generation, comprising:
extracting metadata from an image file associated with an image including geographical information related to a location at which the image was captured and date and time information related to when the image was captured;
performing image recognition to identify one or more objects, shapes, features, or textures in the image;
automatically tagging the image with information or code related to the one or more objects, shapes, features, or textures;
determining a corresponding detail of an identified object or shape of the one or more objects, shapes, features, or textures by:
using information or code related to the identified object or shape and the geographical information to query at least one database for matching the identified object or shape and the location at which the image was captured to the corresponding detail related to the object or shape and the location at which the image was captured, or
using information or code related to the identified object or shape and the date and time information to query at least one database for matching the identified object or shape and when the image was captured to the corresponding detail related to the object or shape and when the image was captured, or
using information or code related to the identified object or shape and both the geographical information and the date and time information to query at least one database for matching the identified object or shape and both the location at which the image was captured and when the image was captured to the corresponding detail related to the object or shape and both the location at which the image was captured and when the image was captured; and
automatically tagging the image with information or code related to the corresponding detail.

12. The method according to claim 11, wherein performing image recognition to identify the one or more objects, shapes, features, or textures in the image uses the geographical information extracted from the image file.

13. The method according to claim 11, comprising performing landmark recognition to identify one or more landmarks in the image; and
automatically tagging the image with information or code related to the one or more landmarks.

14. The method according to claim 13, wherein performing the landmark recognition comprises:
querying a database of architectural or geographical landmarks using information or code related to a selected one or more objects in the image identified during performing the image recognition and the geographical information extracted from the image file.

15. The method according to claim 11, further comprising:
determining a corresponding event condition that was occurring at the location at which the image was captured and during the date and time the image was captured by using the geographical information and the date and time information extracted from the image file associated with the image to query at least one database; and
automatically tagging the image with information or code related to the corresponding event condition.

16. A computer-readable medium comprising computer-readable instructions stored thereon for performing automatic tag generation, the instructions comprising steps for:
extracting metadata from an image file associated with an image, including any geographic information related to a location at which the image was captured;
performing image recognition to identify an object in the image;
determining at least one specific condition corresponding to the object and the location at which the image was captured by:
querying a database for at least one specific condition matching the object and the location at which the image was captured, and
receiving information or code associated with the at least one specific condition from the database; and
automatically tagging the image with the information or code associated with the at least one specific condition.

17. The computer readable medium according to claim 16, wherein the instructions further comprise steps for:
automatically tagging image with a word or code associated with the object in the image after performing the image recognition to identify the object in the image.

18. The computer readable medium according to claim 16, wherein performing the image recognition further comprises using the metadata extracted from the image file to facilitate identifying the object.

19. The computer readable medium according to claim 16, wherein the metadata extracted from the image file includes date and time information related to when the image was captured.

20. The computer readable medium according to claim 19, wherein the information or code associated with the at least one specific condition comprises an event information or code, a weather information or code, a geographical landmark information or code, an architectural landmark information or code, or a combination thereof.
